(19) United States
(12) Patent Application Publication
(10) Pub. No.: US 2011/0128336 A1
(43) Pub. Date: Jun. 2, 2011

(54) PRINTING APPARATUS AND METHOD FOR PRINTING

(75) Inventor: Hiroyuki Onishi, Matsumoto-shi (JP)

(73) Assignee: SEIKO EPSON CORPORATION, Tokyo (JP)

(21) Appl. No.: 12/957,951

(22) Filed: Dec. 1, 2010

(30) Foreign Application Priority Data
Dec. 1, 2009 (JP) 2009-273170

(51) Int. Cl. B41J 2/01

(52) U.S. Cl. 347/102

(57) ABSTRACT

A printing apparatus includes a head which discharges coating ink which coats a medium and electromagnetic radiation-curable ink for image formation having a surface tension lower than the surface tension of the coating ink, a curing unit which irradiates the electromagnetic radiation-curable ink for image formation with electromagnetic waves to cure the electromagnetic radiation-curable ink for image formation, and a controller which makes the head execute a first discharge processing of discharging the coating ink to coat the medium and makes the head execute a second discharge processing of discharging the electromagnetic radiation-curable ink for image formation onto the medium coated by the coating ink to form an image in this order, and then, makes the curing unit execute a curing processing of irradiating the electromagnetic radiation-curable ink for image formation discharged onto the medium with the electromagnetic waves to cure the electromagnetic radiation-curable ink for image formation.

### BACKGROUND

1. Technical Field

The present invention relates to a printing apparatus and a method for printing.

2. Related Art

Printing apparatuses having a head which discharges ink onto a medium has been already well-known. As such a printing apparatus, an ink jet printer has been known, for example. There is a printing apparatus which uses electromagnetic radiation-curable ink which is cured by irradiating the ink with electromagnetic waves such as ultraviolet rays or the like among such printing apparatuses. The printing apparatus includes a curing unit which cures electromagnetic radiation-curable ink by irradiating the electromagnetic radiation-curable ink with electromagnetic waves.

JP-A-2009-184206 is an example of related art.

In the above printing apparatus, the following problematic phenomenon has occurred in some case. That is, the electromagnetic radiation-curable ink discharged onto a medium permeates into the medium deeply and the deeply permeated electromagnetic radiation-curable ink is not appropriately irradiated with electromagnetic waves, resulting in that the electromagnetic radiation-curable ink is not cured appropriately. In particular, when a medium having ink permeability (for example, high-quality sheet) is used as a medium, the above phenomenon has occurred significantly. Further, in such a case, image quality of an image deteriorates due to bleeding of the electromagnetic radiation-curable ink in some case.

### SUMMARY

An advantage of some aspects of the invention is to provide a printing apparatus and a method for printing employing a technique of suppressing image quality of an image from deteriorating.

A printing apparatus according to an aspect of the invention includes a head which discharges coating ink which coats a medium and electromagnetic radiation-curable ink for image formation having a surface tension lower than the surface tension of the coating ink onto the medium, a curing unit which irradiates the electromagnetic radiation-curable ink for image formation with electromagnetic waves to cure the electromagnetic radiation-curable ink for image formation, and a controller which makes the head execute a first discharge processing of discharging the coating ink to coat the medium and makes the head execute a second discharge processing of discharging the electromagnetic radiation-curable ink for image formation onto the medium coated by the coating ink to form an image in this order, and then, makes the curing unit execute a curing processing of irradiating the electromagnetic radiation-curable ink for image formation discharged onto the medium with the electromagnetic waves to cure the electromagnetic radiation-curable ink for image formation, when printing is performed.

Other characteristics of the invention will be obvious by the description of the present specification and accompanying drawings.

### BRIEF DESCRIPTION O THE DRAWINGS

The invention will be described with reference to the accompanying drawings, wherein like numbers reference like elements.

FIG. 1 is a block diagram illustrating a printer according to the embodiment.

FIG. 2 is a schematic cross-sectional view illustrating the printer.

FIG. 3 is a flowchart for explaining a printing operation of the printer.

FIG. 4 is a conceptual view for explaining a coating region according to a second embodiment.

FIG. 5 is a conceptual view for explaining a coating region according to a third embodiment.

### DESCRIPTION OF EXEMPLARY EMBODIMENTS

At least the following matters will be obvious by the present specification and accompanying drawings.

A printing apparatus includes a head which discharges coating ink which coats a medium and electromagnetic radiation-curable ink for image formation having a surface tension lower than the surface tension of the coating ink onto the medium, a curing unit which irradiates the electromagnetic radiation-curable ink for image formation with electromagnetic waves to cure the electromagnetic radiation-curable ink for image formation, and a controller which makes the head execute a first discharge processing of discharging the coating ink to coat the medium and makes the head execute a second discharge processing of discharging the electromagnetic radiation-curable ink for image formation onto the medium coated by the coating ink to form an image in this order, and then, makes the curing unit execute a curing processing of irradiating the electromagnetic radiation-curable ink for image formation discharged onto the medium with the electromagnetic waves to cure the electromagnetic radiation-curable ink for image formation, when printing is performed.

According to the printing apparatus, image quality of an image can be suppressed from deteriorating.

Further, it is preferable that the controller make the head execute the first discharge processing and the second discharge processing such that only part of region including an image formation region on which the image is formed is coated in an entire region on the medium.

In this case, image quality of an image can he effectively suppressed from deteriorating.

Further, it is preferable that the controller make the head execute the first discharge processing and the second discharge processing such that a coating region to be coated is wider beyond the image formation region.

In this case, image quality of an image can be reliably suppressed from deteriorating

Further, it is preferable that the curing unit be a complete-curing unit which completely cures the electromagnetic radiation-curable ink for image formation, the printing apparatus further include a semi-curing unit which irradiates the electromagnetic radiation-curable ink for image formation with electromagnetic waves to semi-cure the electromagnetic radiation-curable ink for image formation, separately from the complete-curing unit, and when printing is performed, the controller make the head execute the first discharge processing and make the head execute the second discharge processing in this order, and then, the controller make the semi-curing unit execute a semi-curing processing of irradiating the electromagnetic radiation-curable ink for image formation discharged onto the medium with the electromagnetic waves to semi-cure the electromagnetic radiation-curable ink for image formation and make the complete-curing unit execute a complete-curing processing of completely curing the electromagnetic radiation-curable ink for image formation in this order.

In this case, image quality of an image can be suppressed from deteriorating more appropriately.

Further, it is preferable that the coating ink be electromagnetic radiation-curable ink for coating, and when printing is performed, the controller make the head execute the first discharge processing and make the semi-curing unit execute a first semi-curing processing of irradiating the electromagnetic radiation-curable ink for coating discharged onto the medium with the electromagnetic waves to semi-cure the electromagnetic radiation-curable ink for coating in this order, then, the controller make the head execute the second discharge processing and make the semi-curing unit execute a second semi-curing processing of semi-curing the electromagnetic radiation-curable ink for image formation in this order, and then, the controller make the complete-curing unit execute the complete-curing processing.

In this case, image quality of an image can be suppressed from deteriorating still more appropriately.

Next, a printing method includes making a head execute a first discharge processing of discharging coating ink to coat the medium, making the head execute a second discharge processing of discharging electromagnetic radiation-curable ink for image formation having a surface tension lower than the surface tension of the coating ink onto the medium coated by the coating ink to form an image, and making a curing unit execute a curing processing of irradiating the electromagnetic radiation-curable ink for image formation discharged onto the medium with the electromagnetic waves to cure the electromagnetic radiation-curable ink for image formation.

According to the printing method, image quality of an image can be suppressed from deteriorating.

### Outline of Printer 1

### Configuration of Printer 1

An embodiment is described with a printing system in which an ink jet printer (hereinafter, referred to as printer 1) which is an example of a printing apparatus and a computer 60 are connected to each other.

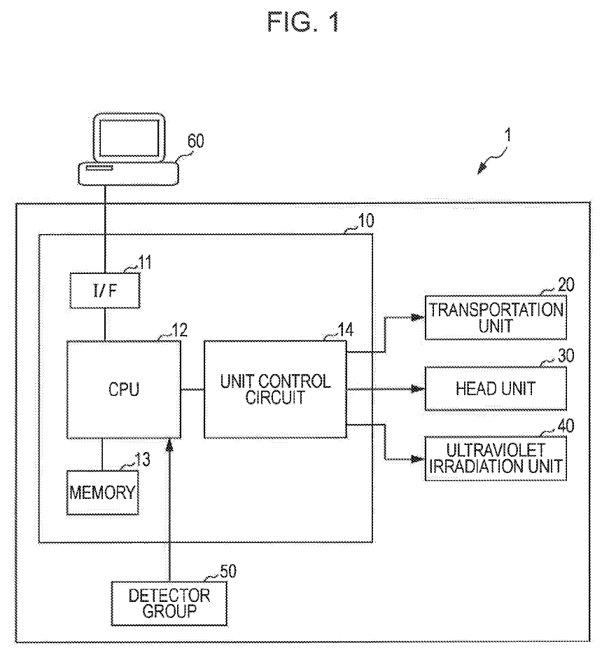

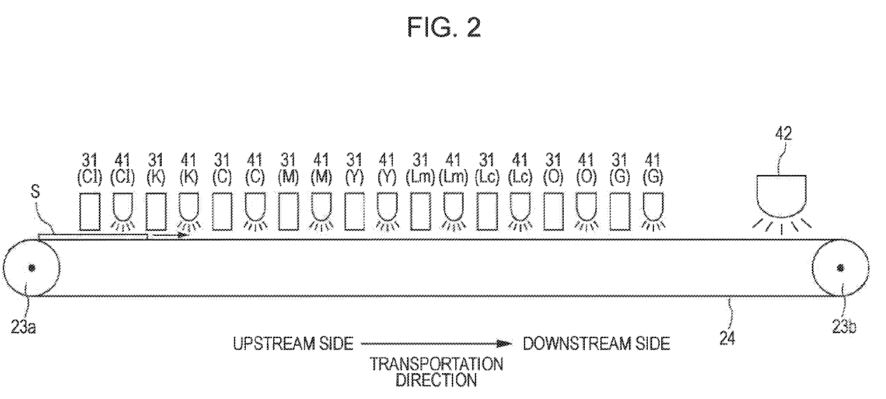

FIG. 1 is a block diagram illustrating an entire configuration of the printer 1 according to the embodiment. FIG. 2 is a schematic cross-sectional view illustrating the printer 1. The printer 1 which has received a print instruction (print data) from the computer 60 as an external device makes a controller 10 control each unit is transportation unit 20, a head unit 30, an ultraviolet irradiation unit 40) to form an image on a sheet S. Further, a detector group 50 monitors a state in the printer 1 and the controller 10 controls each unit based on the detection result of the monitoring.

The controller 10 is a control unit for controlling the printer 1. An interface unit 11 is a unit for transmitting and receiving data between the computer 60 as an external device and the printer 1. A CPU 12 is an arithmetic processing unit for controlling the entire printer 1. A memory 13 holds a region for storing programs of the CPU 12, operation regions, and the like. The CPU 12 controls each unit through a unit control circuit 14 in accordance with programs stored in the memory 13.

The transportation unit 20 is a unit for transporting the sheet S as an example of media in the predetermined direction (hereinafter, referred to as transportation direction). The transportation unit 20 has an upstream side transportation roller 23a and a downstream side transportation roller 23b, and a belt 24, as shown in FIG. 2. If a transportation motor (not shown) rotates, the upstream side transportation roller 23a and the downstream side transportation roller 23b rotate so that the belt 24 rotates. The sheet S fed by a sheet feeding roller (not shown) is transported to a printable region (region opposed to the head) by the belt 24. The belt 24 transports the sheet S so that the sheet S moves to the head unit 30 in the transportation direction. The sheet S which has passed through the printable region is discharged to the outside by the belt 24. It is to be noted that during transportation, the sheet S is electrostatically adsorbed or vacuum-adsorbed to the belt 24.

The head unit 30 has heads 31 for discharging ink onto the sheet. In the printer 1 as shown in FIG. 2, a plurality of heads 31 which discharge different inks onto the sheet S are provided. A plurality of nozzles as ink discharging units are provided on a bottom surface of each of the heads 31. A pressure chamber (not shown) in which ink is held and a driving device (for example, piezoelectric device) for discharging ink by changing a capacity of the pressure chamber are provided on each nozzle. A driving signal is applied to the driving device so that the driving device deforms. In accompanied with the deformation of the driving device, the pressure chamber expands or contracts so that ink is discharged.

In the embodiment, ultraviolet radiation-curable ink as an example of electromagnetic radiation-curable ink is used as ink (in general, ink is a conceptual expression including both water-based ink and oil-based ink). The electromagnetic radiation-curable ink is cured by irradiating the electromagnetic radiation-curable ink with ultraviolet rays as an example of electromagnetic waves. It is to be noted that the ultraviolet radiation-curable ink is ink including ultraviolet radiation-curable resin, photopolymerization reaction occurs in the ultraviolet radiation-curable resin upon irradiation with ultraviolet rays so that the ultraviolet radiation-curable ink is cured.

The printer 1 can discharge one colorless, transparent ultraviolet radiation-curable ink and eight ultraviolet radiation-curable color inks. The colorless transparent ultraviolet radiation-curable ink is a clear ink CI. The eight ultraviolet radiation-curable color inks are black ink K, cyan ink C, magenta ink M, yellow ink Y, light magenta is Lm, light cyan ink Lc, orange ink O, and green ink G. At this time, although eight ultraviolet radiation-curable color inks serve as inks for image formation, the clear ink CI coating ink for coating the sheet S. That is to say, the eight ultraviolet radiation-curable color inks (hereinafter, also referred to as color ink simply) correspond to electromagnetic radiation-curable inks for image formation and the clear ink CI corresponds to coating ink (electromagnetic radiation-curable ink for coating). As will be described later in detail, the controller 10 in the printer 1 according to the embodiment makes the head 31 execute a first discharge processing of discharging the clear ink CI as the coating ink to coat the sheet S. Then, the controller 10 makes the heads 31 execute a second discharge processing of discharging color inks onto the sheet S coated with the clear ink CI to form an image. In the embodiment, any of the color inks have surface tensions lower than the surface tension of the clear ink CI (that is, surface tensions of any of the color inks are lower than the surface tension of the clear ink). The surface tension of ink can be controlled by adjusting an additive amount of a surfactant agent to the ink. The surface tension of each of the clear ink and the color inks according to the embodiment can be controlled by such a method so as to realize the above-described high-low relationship. To be more specific, the surface tension of each color ink is set to be (is controlled to be) greater than or equal to 25 mN/m and less than or equal to 30 mN/m, and the surface tension of the clear ink is set to be (is controlled to be) greater than or equal to 35 mN/m and less than or equal to 40 mN/m. Note that the reason that the sheet S is coated by discharging the clear ink CI before an image is formed by discharging the color inks and the reason that the above high-low relationship is set for the surface tensions of inks are described later in detail.

As shown in FIG. 2, nine heads 31 are provided so as to correspond to the clear ink CI and each of the eight different color inks. To be more specific, as the heads 31, a head 31 (CI) which discharges the clear ink CI, a head 31(K) which discharges the black ink K, a head 31(C) which discharges the cyan ink C, a head 31 (M) which discharges the magenta ink M, a head 31(Y) which discharges the yellow ink Y, a head 31 (Lm) which discharges the light magenta ink Lm, a head 31 (Lc) which discharges the light cyan ink Lc, a head 31 (O) which discharges the orange ink O, and a head 31 (G) which discharges the green ink G are provided in this order from an upstream side to a downstream side in the transportation direction.

The ultraviolet irradiation unit 40 is a unit for irradiating the inks discharged by the heads 31 onto the sheet S with ultraviolet rays to cure the inks. The ultraviolet irradiation unit 40 includes pre-irradiation units 41 (corresponding to the semi-curing unit) and a complete irradiation unit 42 (corresponding to the curing unit and the complete-curing unit) The pre-irradiation units 41 irradiate the inks with ultraviolet rays to semi-cure the inks. The complete irradiation unit 42 irradiates the inks with ultraviolet rays to completely cure the inks. Each of the pre-irradiation units 41 and the complete irradiation unit 42 has a lamp which irradiates inks with ultraviolet rays so as to cure the inks. As the lamp, the pre-irradiation units 41 have an LED, for example, and the complete irradiation unit 42 has an LED, a mercury lamp, or a metal halide lamp, for example.

The pre-irradiation units 41 irradiate inks with ultraviolet rays having lower irradiation intensity in comparison with that of the complete irradiation unit 42. Therefore, inks discharged from the heads 31a are not completely cured with ultraviolet rays irradiated by the pre-irradiation units 41 (semi-curing). On the other hand, the inks are completely cured with ultraviolet rays irradiated by the complete irradiation unit 42 (complete-curing).

In the printer 1 according to the embodiment, a plurality of pre-irradiation units 41 corresponding to each of the plurality of heads 31 are provided in order to irradiate each of the above-described nine different inks discharged by each of the plurality of heads 31. To be more specific, a pre-irradiation unit 41(CI) which corresponds to the head 31(CI) for discharging the clear ink CI and is positioned at a downstream side of the head 31(CI) a pre-irradiation unit 41 (K) which corresponds to the head 31(K) for discharging the black ink K and is positioned at a downstream side of the head 31(K), as pre-irradiation unit 41(C) which corresponds to the head 31(C) for discharging the cyan ink C and is positioned at a downstream side of the head 31(C), a pre-irradiation unit 41(M) which corresponds to the head 31(M) for discharging the magenta ink M and is positioned at a downstream side of the head 31(M), a pre-irradiation unit 41(Y) which corresponds to the head 31(Y) for discharging the yellow ink Y and is positioned at a downstream side of the head 31(Y), a pre-irradiation unit 41(Lm) which corresponds to the head 31(Lm) for discharging the light magenta ink Lm and is positioned at a downstream side of the head 31(Lm), a pre-irradiation unit 41(Lc) which corresponds to head 31(Lc) for discharging the light cyan ink Lc and is positioned at a downstream side of the head 31(Lc), a pre-irradiation unit 41(O) which corresponds to the head 31(O) for discharging the orange ink O and is positioned at a downstream side of the head 31(O) and a pre-irradiation unit 41(G) which corresponds to the head 31(G) for discharging the green ink G and is positioned at a downstream side of the head 31(G) are provided in this order from the upstream side to the downstream side in the transportation direction. At this time, the pre-irradiation unit 41(CI) irradiates the clear ink CI, the pre-irradiation unit 41 (K) irradiates the black ink K, the pre-irradiation unit 41(C) irradiates the cyan ink C, the pre-irradiation unit 41(M) irradiates the magenta ink M, the pre-irradiation unit 41(Y) irradiates the yellow ink Y, the pre-irradiation unit 41(Lm) irradiates the light magenta ink Lm, the pre-irradiation unit 41(Lc) irradiates the light cyan ink Lc, the pre-irradiation unit 41(O) irradiates the orange ink O and the pre-irradiation unit 41(G) irradiates the green ink G. Further, only one complete irradiation unit 42 is provided at the downstream-most side in the transportation direction.

### Operation of Printer 1

The printer 1 according to the embodiment includes a large number of printing modes. As examples thereof, a printing mode (hereinafter, referred to as a first printing mode) where a color image is printed by using cyan ink, magenta ink, and yellow ink, a printing mode (hereinafter, referred to as a second printing mode) where a color image is printed by using all color inks, and the like. Further, all of the above nine heads 31 and the nine pre-irradiation units 41 are not always used and the heads 31 and the pre-irradiation units 41 to be used are different depending on the printing modes. That is to say, when printing is performed in the first printing mode, three heads 31 each of which discharges each of the three color inks corresponding to the cyan ink, the magenta ink, and the yellow ink and three pre-irradiation units 41 each of which corresponds to each of these three heads are operated. On the other hand, when printing is performed in the second printing mode, eight heads 31 each of which discharges each of these eight color inks and the eight pre-irradiation units 41 each of which corresponds to each of these eight heads are operated. In the embodiment, in any printing modes, the head 31(CI) which discharges the clear ink CI and the pre irradiation unit 41(CI) which corresponds to the head 31(CI) are operated.

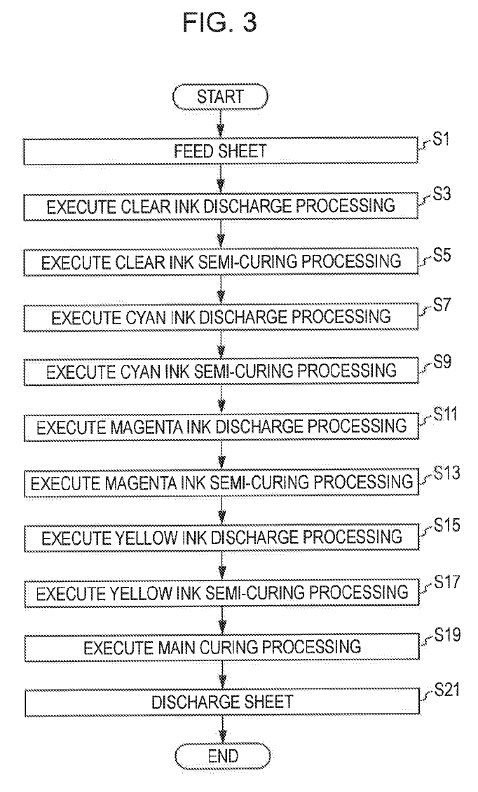

Hereinafter, a printing operation of the printer 1 is described with reference to FIG. 3 by taking an operation when printing is performed in the first printing mode as an example. FIG. 3 is a flowchart for explaining the printing operation of the printer 1. Various types of operations of the printer 1 when printing is performed are mainly performed by the controller 10. In particular, in the embodiment, the CPU 12 processes the programs stored in the memory 13 so that the operations are performed. Further, the programs are formed with codes for performing various types of operations which will be described below.

The controller 10 feeds the sheet S onto the belt 24 upon reception of the print data (step S1).

The sheet S is transported at a constant speed by the belt 24 without stopping and is eventually opposed to the head 31(CI). At this time, the controller 10 makes the head 31(CI) execute a clear ink discharge processing (corresponding to a first discharge processing) of discharging the clear ink CI to coat the sheet S (step S3). Next, the controller 10 makes the pre-irradiation unit 41(CI) execute a clear ink semi-curing processing (corresponding to a first curing processing) of irradiating the clear ink CI discharged onto the sheet S with ultraviolet rays to semi-cure the clear ink CI (step S5, the sheet S is continuously transported during the processing).

Subsequently, the controller 10 makes the heads 31 execute a color ink discharge processing (corresponding to a second discharge processing) of discharging the color inks onto the sheet S coated with the clear ink to form an image, And then, the controller 10 makes the pre-irradiation units 41 execute a color ink semi-curing processing (corresponding to a semi-curing processing and a second semi-curing processing) of irradiating the color inks discharged onto the sheet S with ultraviolet rays to semi-cure the color inks. To be more specific, the controller 10 makes the head 31(C) execute a cyan ink discharge processing of discharging the cyan ink C onto the sheet S, at first (step S7). Next, the controller 10 makes the pre-irradiation unit 41(C) execute a cyan ink semi-curing processing of irradiating the cyan ink C with ultraviolet rays to semi-cure the cyan ink C (step S9). Subsequently, the controller 10 controls the head 31(M), the pre-irradiation unit 41(M), the head 31(Y), and the pre-irradiation unit 41(Y) so as to execute a magenta ink discharge processing, a magenta ink semi-curing processing, a yellow ink discharge processing, and a yellow ink semi-curing processing (step S11, S13, S15, S17, discharging of inks and pre-irradiation are finished at this time).

After the pre-irradiation is finished, the controller 10 makes the complete irradiation unit 42 execute the complete-curing processing of irradiating inks (in the embodiment, the clear ink and three different color inks) discharged onto the medium with ultraviolet rays to completely cure the inks (step S19). With this, printing of an image onto the sheet S is completed and the sheet S is discharged to the outside (step S21).

It is to be noted that in the embodiment, the entire region on the sheet S is coated in order to simplify processings in the printer 1 irrespective of a range of the image formation region on which an image is formed. That is to say, the controller 10 makes the head 31(CI) execute coating of the entire region, which is performed by discharging the clear ink CI onto the entire region on the sheet S.

### Effectiveness of Printer 1 According to the Embodiment

As described above, the printer 1 according to the embodiment has the heads 31 which discharge the clear ink CI for coating the sheet S, and color inks for image formation having surface tensions lower than the surface tension of the clear ink CI, the complete irradiation unit 42 which irradiates the color inks with ultraviolet rays to cure the color inks, and the controller 10 which makes the head 31(CI) execute the clear ink discharge processing of discharging the clear ink CI to coat the sheet S and makes the heads 31 execute the color ink discharge processing of discharging the color inks onto the sheet S coated by the clear ink CI to form an image in this order, and then, makes the complete irradiation unit 42 execute the complete-curing processing of irradiating the color inks discharged onto the sheet S with ultraviolet rays to completely cure the color inks, when printing is performed. With this, image quality of an image can be suppressed from deteriorating.

The above effect is described by comparing the printer 1 according to the embodiment and a printer 1 according to a comparative example with each other. The printer 1 according to the comparative example is the same as the printer 1 according to the embodiment in the following point. That is, in the comparative example, the controller 10 makes the heads 31 execute the color ink discharge processing by discharging the color inks onto the sheet to form an image, and then, makes the complete irradiation unit 42 execute the complete-curing processing of irradiating the color inks discharged onto the sheet with the ultraviolet rays to completely cure the color inks in the same manner as the printer 1 according to the embodiment. However, the head 31(CI) which discharges the clear ink CI for coating onto the sheet S is not provided in the printer 1 according to the comparative example. Therefore, the sheet S is not coated by discharging the clear ink CI before the color inks are discharged to form an image in the printer 1 according to the comparative example. Therefore, the following problems arise in the printer 1 according to the comparative example.

That is to say, the following problematic phenomenon occurs in some case. The color inks discharged onto the sheet S permeate into the sheet S deeply (that is, deeply in the sheet thickness direction) in the color ink discharge processing at the time of printing. Further, the deeply permeated color inks are not appropriately irradiated with ultraviolet rays in the complete-curing processing, resulting in that the color inks are not cured appropriately. In particular, when a medium having ink permeability (for example, high-quality sheet) is used as a medium, the above phenomenon occurs significantly. Further, in such a case, image quality of an image deteriorates due to problems caused by curing failure of the color inks (bleeding of the color inks or the like) in some case. In addition, distinctive odor of ultraviolet radiation-curable ink remains due to the curing failure of the color inks in some case.

In comparison therewith, in the embodiment, after the sheet S is coated by discharging the clear ink CI having a surface tension higher than those of the color inks, color inks having surface tensions lower than the surface tension of the clear ink CI are discharged onto the sheet S coated with the clear ink CI to form an image. Therefore, the color inks are suppressed from permeating into the sheet S deeply with such effect that the clear ink CI blocks the color inks. Further, the phenomenon that the color inks are not appropriately irradiated with ultraviolet rays can be suppressed from occurring. Accordingly, problems caused by curing failure of the color inks (bleeding of the color inks or the like) can be suppressed from occurring and image quality of an image can be suppressed from deteriorating.

Further, since the sheet S is coated with the clear ink CI having a higher surface tension, the clear ink CI does not permeate into the sheet S as much as the color inks in the comparative example. It is needless to say that as the surface tension of ink is higher, permeation degree into the sheet S becomes smaller. Accordingly, a problem occurred because the clear ink CI deeply permeates into the sheet S can be suppressed from occurring and image quality of an image can be also suppressed from deteriorating in this point.

Further, since the color inks having lower surface tensions are discharged onto the coated sheet S, so-called repellence is suppressed from occurring. Note that the repellence (mottling) is a phenomenon that ink aggregates because the surface tension of ink is high and portions having agglomerate of ink droplets and portions having no ink are generated to cause irregularity. Therefore, image quality of an image can be also suppressed from deteriorating in this point.

In addition, the embodiment has an advantage in the viewpoint of not only the image quality of an image but also odor, as described later. That is to say, the color inks are suppressed from permeating into the sheet S deeply with an effect that the clear ink CI blocks the color inks. Further, a phenomenon that the color inks are not appropriately irradiated with ultraviolet rays can be suppressed from occurring. Accordingly, a problem that distinctive odor of ultraviolet radiation-curable ink remains due to curing failure of the color inks is suppressed from occurring.

Further, since the sheet S is coated with the clear ink CI having a higher surface tension, the clear ink CI does not permeate into the sheet S as much as the color inks in the comparative example. Accordingly, a problem that the clear ink CI is not appropriately irradiated with ultraviolet rays and the odor remains because the clear ink CI deeply permeates into the sheet S is also suppressed from occurring.

### Coating Region

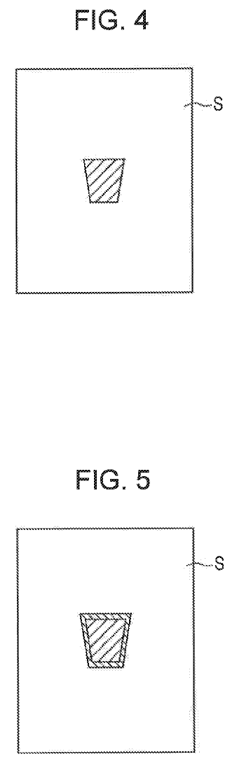

In the embodiment, the entire region on the sheet S is coated irrespective of a range of the image formation region where an image is formed. However, the coating region is not limited thereto and other examples can be considered. In this section, other examples are described with reference to FIG. 4 and FIG. 5 by referring two examples. FIG. 4 is a conceptual view for explaining a coating region according to a second embodiment. FIG. 5 is a conceptual view for explaining a coating region according to a third embodiment. It is to be noted that a simplified picture of a cup is printed on the sheet S in FIG. 4 and FIG. 5. Further, an example illustrated in the previous section is set to a first embodiment and the following two examples are set to a second embodiment and a third embodiment, respectively, for convenience of description.

In the printer 1 according to the second embodiment, the controller 10 makes the heads 31 execute the above-described clear ink discharge processing and color ink discharge processing such that only a part of region including an image formation region where an image is formed is coated in the entire region on the sheet S. An expression “including an image formation region is not limited to a meaning including the entire image formation region”. That is, not likely in the first embodiment, the entire region on the sheet S is not coated and there is some region where coating is not performed on the sheet S in the second embodiment.

In FIG. 4, upward-sloping line area corresponds to the image formation region, downward-sloping line area corresponds to the coating region to he coated. As is obvious from FIG. 4, the part of region (that is, coating region) equals to the image formation region in the second embodiment (although not limited thereto).

In the printer 1 according to the second embodiment, since the clear ink CI is saved in comparison with the first embodiment, image quality of an image can be effectively suppressed from deteriorating.

In the second embodiment, the controller 10 determines a coating region (in other words, pixels to which the clear ink CI is discharged) based on the print data received from the computer 60 and including information about the image formation region (in other words, information about pixels to which color inks are discharged). However, the method of determining the coating region is not limited thereto and the coating region which may be determined at the computer 60 side based on the print data and information about the determined coating region may be transmitted to the printer 1 together with the print data.

Next, the third embodiment is described. In the printer 1 according to the third embodiment, the controller 10 makes the heads 31 execute the above-described clear ink discharge processing and color ink discharge processing such that only part of region including an image formation region where an image is formed is coated in the entire region on the sheet S as in the second embodiment. However, the third embodiment is different from the second embodiment in that the controller 10 makes the heads 31 execute the clear ink discharge processing and the color ink discharge processing such that the coating region to be coated is wider beyond the image formation region.

In FIG. 5 upward-sloping line area corresponds to the image formation region, downward-sloping line area corresponds to the coating region to be coated as in FIG. 4. As is obvious from FIG. 5, the coating region is wider beyond the image formation region in the third embodiment.

In the printer 1 according to the third embodiment, in addition to the effect of the second embodiment, that is, an effect that image quality of an image can be effectively suppressed from deteriorating, the image formation region can be reliably coated and image quality of an image can be reliably suppressed from deteriorating.

In the third embodiment, the controller 10 also determines a coating region (in other words, pixels to which the clear ink CI is discharged) based on the print data received from the computer 60 and including information about the image formation region (in other words, information about pixels to which color inks are discharged) as in the second embodiment. In one example, the controller 10 grasps pixels to which color inks are discharged based on the print data and sets pixels to which the color inks are discharged and adjacent pixels to which the color inks are not discharged (the adjacent pixels correspond to the coating region which is wider beyond the image formation region). Then, the controller 10 determines the pixels to which clear ink (CI) is discharged. It is sufficient that the coating region is determined in such a manner. It is to be noted that in the third embodiment, the coating region may be also determined at the computer 60 side based on the print data and information about the determined coating region which may be transmitted to the printer 1 together with the print data.

### OTHER EMBODIMENTS

In the above embodiments, a printing apparatus is mainly described. However, the above embodiments include disclosure of a method for punting and the like. Further, the embodiments are described for making the invention understood easily and are not intended to limit the invention. It is needless to say that the invention can be changed or modified without departing from a scope of the invention and the invention encompasses the equivalents thereof. In particular, the following embodiments are encompassed in the invention.

In the above embodiments, a printing apparatus is embodied as an ink jet printer. However, the invention is not limited thereto and can be applied to other printing apparatuses. Further, although a so-called line printer is taken as an example of the ink jet printer, the invention can be also applied to a so-called serial printer.

Further, although ultraviolet radiation-curable ink is exemplified as electromagnetic radiation-curable ink in the above embodiments, the electromagnetic radiation-curable ink is not limited thereto. For example, the electromagnetic radiation-curable ink may be ink which is cured with electromagnetic waves such as electron beams, X-rays, visible light rays, and infrared rays.

Further, although the sheet S is exemplified as a medium in the above embodiments, the medium is not limited thereto. For example, the medium may be a fabric,

Further, although the clear ink CI is exemplified as coating ink in the above embodiments, the coating ink is not limited thereto. For example, the coating ink may be white ink, or metallic ink.

In addition, in the above embodiments, when printing is performed, after the clear ink discharge processing is executed by the head 31, the color ink discharge processing is executed by the heads 31. Then, after the semi-curing processing of irradiating the color inks discharged onto the sheet S with ultraviolet rays to semi-cure the color inks is executed by the pre-irradiation units 41, the complete-curing processing of completely curing the color inks is executed by the complete irradiation unit 42. However, the invention is not limited thereto. For example, the semi-curing processing may not be executed. Accordingly, the invention can be applied to a printer 1 without the pre-irradiation units 41.

However, in a case where the semi-curing processing is executed as in the above embodiments, a moderation effect for ink permeation is achieved (ink does not permeate deeply with the semi-curing) because viscosity of ink is increased by the semi-curing processing. Therefore, image quality of an image can be further suppressed from deteriorating in comparison with a case where the semi-curing processing is not executed. Further, a problem that odor remains is suppressed from occurring more appropriately.

Further, in the above embodiments, when printing is performed, after the clear ink discharge processing is executed by the head 31, the clear ink semi-curing processing of irradiating the clear ink CI discharged onto the sheet S with ultraviolet rays to semi-cure the clear ink CI is executed by the pre-irradiation unit 41(CI), and then, after the color ink discharge processing is executed by the heads 31 and the color ink semi-curing processing of semi-curing the color inks is executed by the pre-irradiation units 41, thereafter, the complete curing processing is executed by the complete irradiation unit 42. However, the invention is not limited thereto. For example, the invention can be applied to the printer 1 in which the clear ink semi-curing processing may not be executed between the clear ink discharge processing and the color ink discharge processing and, after the clear ink discharge processing and the color ink discharge processing are finished, the semi-curing processing and the complete-curing processing are executed.

However, in a case where the clear ink semi-curing processing is executed as in the above embodiments, a moderation effect for ink permeation is achieved (ink does not permeate deeply with the semi-curing) because viscosity of the clear ink is increased by the clear ink semi-curing processing. Therefore, image quality of an image can be still further suppressed from deteriorating in comparison with a case where the semi-curing processing is not executed. Further, a problem that odor remains is suppressed from occurring still more appropriately.

The entire disclosure of Japanese Patent Application No. 2009-273170, filed Dec. 1, 2009 is expressly incorporated by reference herein.

What is claimed is

1. A printing apparatus comprising:
a head which discharges coating ink which coats a medium and electromagnetic radiation-curable ink for image formation having a surface tension lower than the surface tension of the coating ink onto the medium;
a curing unit which irradiates the electromagnetic radiation-curable ink for image formation with electromagnetic waves to cure the electromagnetic radiation-curable ink for image formation; and
a controller which makes the head execute a first discharge processing of discharging the coating ink to coat the medium and makes the head execute a second discharge processing of discharging the electromagnetic radiation-curable ink for image formation onto the medium coated by the coating ink to form an image in this order, and then, makes the curing unit execute a curing processing of irradiating the electromagnetic radiation-curable ink for image formation discharged onto the medium with the electromagnetic waves to cure the electromagnetic radiation-curable ink for image formation, when printing is performed.

2. printing apparatus according to claim 1,
wherein the controller makes the head execute the first discharge processing and the second discharge processing such that only part of region including an image formation region on which the image is formed is coated in an entire region on the medium.

3. The printing apparatus according to claim 2,
wherein the controller makes the head execute the first discharge processing and the second discharge processing such that a coating region to be coated is wider beyond the image formation region.

4. The printing apparatus according to claim 1,
wherein the curing unit is a complete-curing unit which completely cures the electromagnetic radiation-curable ink for image formation,
the printing apparatus further includes a semi-curing unit which irradiates the electromagnetic radiation-curable ink for image formation with electromagnetic waves to semi-cure the electromagnetic radiation-curable ink for image formation, separately from the complete-curing unit, and
when printing is performed, the controller makes the head execute the first discharge processing and makes the head execute the second discharge processing in this order, and then,
the controller makes the semi-curing unit execute a semi-curing processing of irradiating the electromagnetic radiation-curable ink for image formation discharged onto the medium with the electromagnetic waves to semi-cure the electromagnetic radiation-curable ink for image formation and makes the complete-curing unit execute a complete-curing processing of completely curing the electromagnetic radiation-curable ink for image formation in this order.

5. The printing apparatus according to claim 4,
wherein the coating ink is electromagnetic radiation-curable ink for coating,
when printing is performed, the controller makes the head execute the first discharge processing and makes the semi-curing unit execute a first semi-curing processing of irradiating the electromagnetic radiation-curable ink for coating discharged onto the medium with the electromagnetic waves to semi-cure the electromagnetic radiation-curable ink for coating in this order, then,
the controller makes the head execute the second discharge processing and makes the semi-curing unit execute a second semi-curing processing of semi-curing the electromagnetic radiation-curable ink for image formation in this order, and then
the controller makes the complete-curing unit execute the complete curing processing.

6. A method for printing comprising:
making a head execute a first discharge processing of discharging coating ink to coat the medium;
making the head execute a second discharge processing of discharging electromagnetic radiation-curable ink for image formation having a surface tension lower than the surface tension of the coating ink onto the medium coated by the coating ink to form an image; and
making a curing unit execute a curing processing of irradiating the electromagnetic radiation-curable ink for image formation discharged onto the medium with the electromagnetic waves to cure the electromagnetic radiation-curable ink for image formation.
